(19) United States
(12) Patent Application Publication
(10) Pub. No.: US 2025/0023923 A1
(43) Pub. Date: Jan. 16, 2025

(54) VEHICLE ON-BOARD NETWORK SYSTEM, GATEWAY, AND COMMUNICATION METHOD

(71) Applicant: TOYOTA JIDOSHA KABUSHIKI KAISHA, Toyota-shi (JP)

(72) Inventor: Seigo TAKAI, Nagoya-shi (JP)

(73) Assignee: TOYOTA JIDOSHA KABUSHIKI KAISHA, Toyota-shi (JP)

(21) Appl. No.: 18/765,415

(22) Filed: Jul. 8, 2024

(30) Foreign Application Priority Data
Jul. 12, 2023 (JP) 2023-114569

(51) Int. Cl. H04L 65/102; H04L 12/40; H04L 12/66; H04L 45/00

(52) U.S. Cl. CPC H04L 65/102; H04L 12/40; H04L 12/66; H04L 45/26; H04L 2012/40215; H04L 2012/40273

(57) ABSTRACT

A vehicle on-board network system includes networks, each including electronic control units and a communication bus connecting the electronic control units, and a gateway connected to the networks and configured to allow the electronic control units to communicate with each other in compliance with a CAN protocol. The gateway device includes a processing device configured to refer to a frame included in an activation request message identifying an electronic control unit that needs to be activated to determine a destination of the activation request message so as to transmit the activation request message to only a network that includes the electronic control unit that needs to be activated.

### CROSS-REFERENCE TO RELATED APPLICATIONS

This application is based upon and claims the benefit of priority from prior Japanese Patent Application No. 2023-114569, filed on Jul. 12, 2023, the entire contents of which are incorporated herein by reference.

### BACKGROUND

### 1. Field

The following description relates to a vehicle on-board network system, a gateway, and a communication method.

### 2. Description of Related Art

Japanese Laid-Open Patent Publication No. 2017-144893 discloses a vehicle on-board network system in which electronic control units are mounted on a vehicle and communicate with each other. In the vehicle on-board network system, a controller area network (CAN) protocol is used in communication performed via a communication bus.

A partial network is a known network in which only some of the electronic control units in the vehicle on-board network system are activated while the remaining electronic control units remain in a sleep state. The partial network reduces power consumption in the vehicle on-board network system.

When an electronic control unit adapted to the partial network receives an activation request message including a specified frame individually assigned to the electronic control unit, the electronic control unit shifts to an active state. The active state allows the electronic control unit to execute applications.

When the electronic control unit adapted to the partial network receives an activation request message that does not include the specified frame assigned to the electronic control unit, the electronic control unit ignores the activation request message. Thus, the electronic control unit maintains the sleep state. The sleep state deactivates the function of executing applications so that power consumption is reduced.

An electronic control unit that is not adapted to the partial network does not have a configuration that ignores an activation request message for activating another electronic control unit. Therefore, when receiving the activation request message for activating another electronic control unit, the electronic control unit that is not adapted to the partial network will be activated even though the activation is not necessary.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure is a vehicle on-board network system that includes networks each including electronic control units and a communication bus connecting the electronic control units to each other, and a gateway device connected to the networks and configured to allow the electronic control units to communicate with each other in compliance with a CAN protocol. The gateway device includes processing circuitry. When the gateway device receives an activation request message including a frame identifying one or more of the electronic control units that need to be activated, the processing circuitry is configured to determine a destination of the activation request message. The processing circuitry is configured to determine the destination of the activation request message, with reference to the frame included in the activation request message, so that the gateway device does not transmit the activation request message to one or more of the networks that do not include the one or more of the electronic control units that need to be activated, whereas the gateway device transmits the activation request message to one or more of the networks that include the one or more of the electronic control units that need to be activated.

An aspect of the present disclosure is a gateway device used in a vehicle on-board network system. The vehicle on-board network system includes networks connected to the gateway device, each network includes electronic control units and a communication bus connecting the electronic control units to each other, and the gateway device is configured to relay communication between the electronic control units so that the electronic control units communicate with each other in compliance with a CAN protocol. The gateway device includes processing circuitry. When the gateway device receives an activation request message including a frame identifying one or more of the electronic control units that need to be activated, the processing circuitry is configured to determine a destination of the activation request message. The processing circuitry is configured to determine the destination of the activation request message, with reference to the frame included in the activation request message, so that the gateway device does not transmit the activation request message to one or more of the networks that do not include the one or more of the electronic control units that need to be activated, whereas the gateway device transmits the activation request message to one or more of the networks that include the one or more of the electronic control units that need to be activated.

An aspect of the present disclosure is a communication method in a vehicle on-board network system. The vehicle on-board network system includes networks each including electronic control units and a communication bus connecting the electronic control units to each other and a gateway device connected to the networks and configured to relay communication between the electronic control units so that the electronic control units communicate with each other in compliance with a CAN protocol. The communication method includes with the gateway device, receiving, from at least one of the electronic control units, an activation request message including a frame identifying one or more of the electronic control units that need to be activated; with the gateway device, determining a destination of the activation request message, with reference to the frame included in the activation request message, so that the activation request message is not transmitted to one or more of the networks that do not include the one or more of the electronic control units that need to be activated, whereas the activation request message is transmitted to one or more of the networks that include the one or more of the electronic control units that need to be activated, and with the gateway device, transmitting the activation request message to only the one or more of the networks determined to be the destination.

Other features and aspects will be apparent from the following detailed description, the drawings, and the claims.

### BRIEF DESCRIPTION OF THE DRAWINGS

FIG. 1 is a schematic diagram showing the configuration of a vehicle on-board network system according to one embodiment.

FIG. 2 is a table collectively showing the relationship of combinations of applications simultaneously executed to operate each functional system and networks to which electronic control units including applications belong in the vehicle on-board network system of the embodiment shown in FIG. 1.

FIG. 3 is a schematic diagram showing which electronic control unit is activated in a first case in a first comparative example.

FIG. 4 is a schematic diagram showing which electronic control unit is activated in a second case in the first comparative example.

FIG. 5 is a schematic diagram showing which electronic control unit is activated in a third case in the first comparative example.

FIG. 6 is a schematic diagram showing which electronic control unit is activated in a fourth case in the first comparative example.

FIG. 7 is a schematic diagram showing which electronic control unit is activated in a first case in a second comparative example.

FIG. 8 is a schematic diagram showing which electronic control unit is activated in a second case in the second comparative example.

FIG. 9 is a schematic diagram showing which electronic control unit is activated in a third case in the second comparative example.

FIG. 10 is a schematic diagram showing which electronic control unit is activated in a fourth case in the second comparative example.

FIG. 11 is a flowchart of a series of steps executed by a processing device of a gateway shown in FIG. 1 when receiving an activation request message.

FIG. 12 is a schematic diagram showing which electronic control unit is activated in the first case in the vehicle on-board network system of the embodiment shown in FIG. 1.

FIG. 13 is a schematic diagram showing which electronic control unit is activated in the second case in the vehicle on-board network system of the embodiment shown in FIG. 1.

FIG. 14 is a schematic diagram showing which electronic control unit is activated in the third case in the vehicle on-board network system of the embodiment shown in FIG. 1.

FIG. 15 is a schematic diagram showing which electronic control unit is activated in the fourth case in the vehicle on-board network system of the embodiment shown in FIG. 1.

FIG. 16 is a table collectively showing the relationship of combinations of electronic control units simultaneously operated to operate each functional system and networks in which the electronic control units are arranged in a modified example of a vehicle on-board network system.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

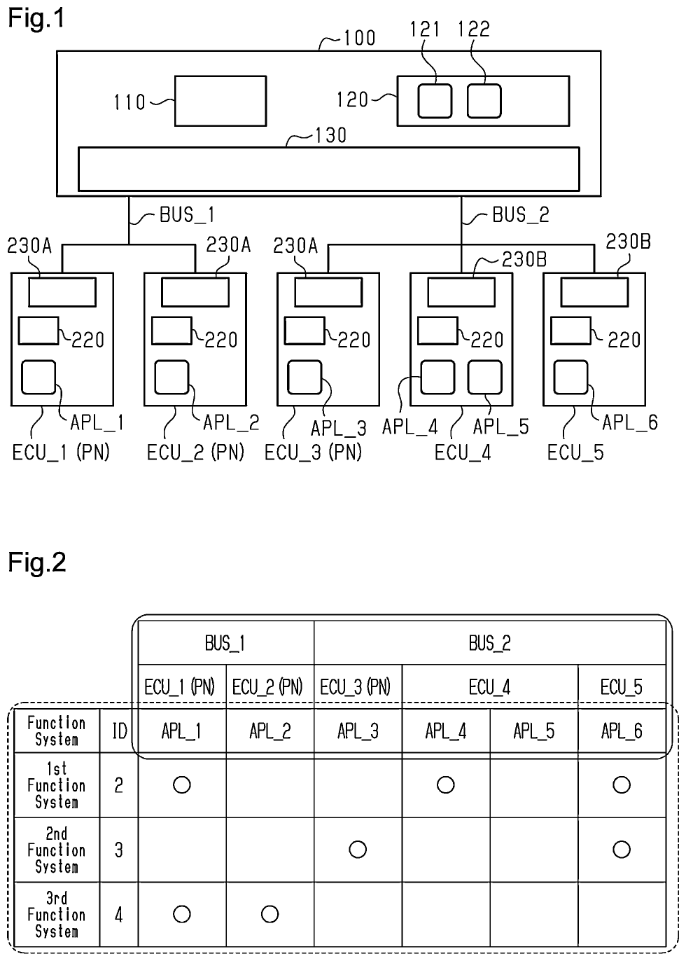

An embodiment of a vehicle on-board network system will now be described with reference to FIGS. 1 to 15.

### Configuration of Vehicle On-Board Network System

FIG. 1 shows the configuration of the vehicle on-board network system of the embodiment. As shown in FIG. 1, the vehicle on-board network system includes a gateway device 100. The vehicle on-board network system includes electronic control units ECU. The electronic control units ECU are connected to the gateway device 100 by communication buses BUS. Some of the electronic control units ECU are connected to each other and to the gateway device 100 by one communication bus BUS. In the vehicle on-board network system, the electronic control units ECU that are connected to each other by one communication bus BUS form one network.

In an example, as shown in FIG. 1, a first communication bus BUS_1 and a second communication bus BUS_2 are connected to the gateway device 100. The first communication bus BUS_1 is connected to a first electronic control unit ECU_1 and a second electronic control unit ECU_2. The second communication bus BUS_2 is connected to a third electronic control unit ECU_3, a fourth electronic control unit ECU_4, and a fifth electronic control unit ECU_5. The first electronic control unit ECU_1 and the second electronic control unit ECU_2 are connected to the gateway device 100 by the first communication bus BUS_1. The third to fifth electronic control units ECU_3 to ECU_5 are connected to the gateway device 100 by the second communication bus BUS_2. The first electronic control unit ECU_1 and the second electronic control unit ECU_2 form a network connected by the first communication bus BUS_1. The third to fifth electronic control units ECU_3 to ECU_5 form a network connected by the second communication bus BUS_2.

Each electronic control unit ECU includes at least one application APL executed by the electronic control unit ECU. For example, as shown in FIG. 1, the first electronic control unit ECU_1 includes a first application APL_1. The second electronic control unit ECU_2 includes a second application APL_2. The third electronic control unit ECU_3 includes a third application APL_3. The fourth electronic control unit ECU_4 includes a fourth application APL_4 and a fifth application APL_5. The fifth electronic control unit ECU_5 includes a sixth application APL_6.

In a vehicle in which the vehicle on-board network system is installed, two or more of the applications APL of the electronic control units ECU are simultaneously executed to implement each function.

FIG. 2 is a table showing combinations of the applications APL executed to implement various functions in the vehicle on-board network system shown in FIG. 1. The functions that are implemented includes various types of function, for example, an automatic parking function, an automatic brake function, a remote door lock function, a remote air conditioner function, and a security function.

In the example shown in FIG. 2, the vehicle includes a first function system, a second function system, and a third function system that implement different functions. As shown in FIG. 2, in the first function system, the first application APL_1, the fourth application APL_4, and the sixth application APL_6 are combined and simultaneously executed to implement the corresponding function. In the second function system, the third application APL_3 and the sixth application APL_6 are combined and simultaneously executed to implement the corresponding function. In the third function system, the first application APL_1 and the second application APL_2 are combined and simultaneously executed to implement the corresponding function.

The electronic control units ECU communicate with each other via the gateway device 100 in compliance with the controller area network (CAN) protocol.

The gateway device 100 includes a processing device 110, a storage device 120, and a transceiver 130. The transceiver 130 is used as a communication interface with the communication buses BUS.

The vehicle on-board network system is configured to form a partial network in which only some of the electronic control units ECU are activated while the remaining electronic control units ECU remain in a sleep state. The partial network reduces power consumption in the vehicle on-board network system.

Each of the electronic control units ECU includes a timer 220 and a transceiver 230. The vehicle on-board network system shifts the electronic control units ECU, when not in use, to the sleep state to reduce power consumption. The timer 220 controls a count value used to shift the electronic control unit ECU to the sleep state. In an example, when an electronic control unit ECU is in the active state, the timer 220 mounted on the electronic control unit ECU regularly increments the count value. Then, when the electronic control unit ECU accepts an activation request message, which will be described later, the timer 220 resets the count value. The electronic control unit ECU shifts to the sleep state when the count value reaches a predetermined value. More specifically, when the activation request message has continuously not been accepted for a fixed length of time, the electronic control unit ECU automatically shifts to the sleep state. In an example, the activation request message is transmitted by any one of the electronic control units ECU.

The transceiver 230 is used as a communication interface with the communication bus BUS. The transceiver 230 includes a transceiver 230A that is adapted to the partial network and a transceiver 230B that is not adapted to the partial network. In the vehicle on-board network system shown in FIG. 1, the first electronic control unit ECU_1, the second electronic control unit ECU_2, and the third electronic control unit ECU_3 each include the transceiver 230A adapted to the partial network. The fourth electronic control unit ECU_4 and the fifth electronic control unit ECU_5 each include the transceiver 230B that is not adapted to the partial network. That is, the first electronic control unit ECU_1, the second electronic control unit ECU_2, and the third electronic control unit ECU_3 are each an electronic control unit ECU that is adapted to the partial network. The fourth electronic control unit ECU_4 and the fifth electronic control unit ECU_5 are each an electronic control unit ECU that is not adapted to the partial network. In the drawings, “PN” in parentheses is provided to the electronic control units ECU adapted to the partial network to indicate that the electronic control units ECU are adapted to the partial network.

### Partial Network

When an electronic control unit ECU adapted to the partial network receives an activation request message including a specified frame that is individually assigned to the electronic control unit ECU, the electronic control unit ECU shifts to the active state. The active state allows the electronic control unit ECU to execute the application APL.

When the electronic control unit ECU adapted to the partial network receives an activation request message that does not include the specified frame assigned to the electronic control unit ECU, the electronic control unit ECU ignores the activation request message. Thus, the electronic control unit ECU maintains the sleep state. The sleep state deactivates the function of executing the application APL so that power consumption is reduced.

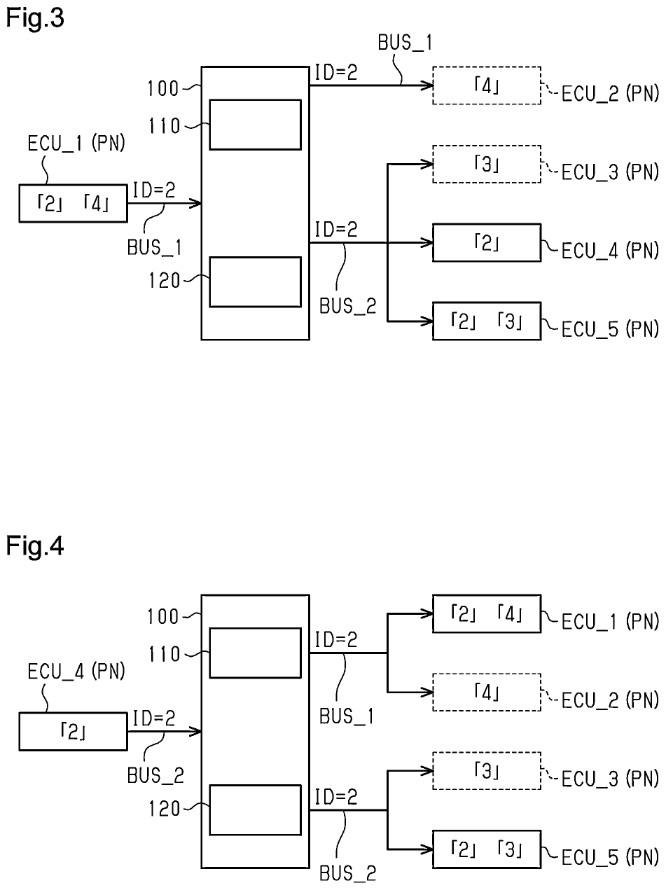

The transceiver 230B of an electronic control unit ECU that is not adapted to the partial network does not have a configuration that ignores an activation request message that does not include a specified frame individually assigned to the electronic control unit ECU. Therefore, when receiving the activation request message for activating another electronic control unit ECU, the electronic control unit ECU that is not adapted to the partial network will be activated even though the activation is not necessary. First to fourth specific cases will now be described with reference to FIGS. 3 to 10.

FIGS. 3 to 10 each show a vehicle on-board network system having the same network configuration as the vehicle on-board network system shown in FIG. 1. As in the vehicle on-board network system shown in FIG. 1, the first to fifth electronic control units ECU_1 to ECU_5 each include at least one of the first to sixth applications APL_1 to APL_6.

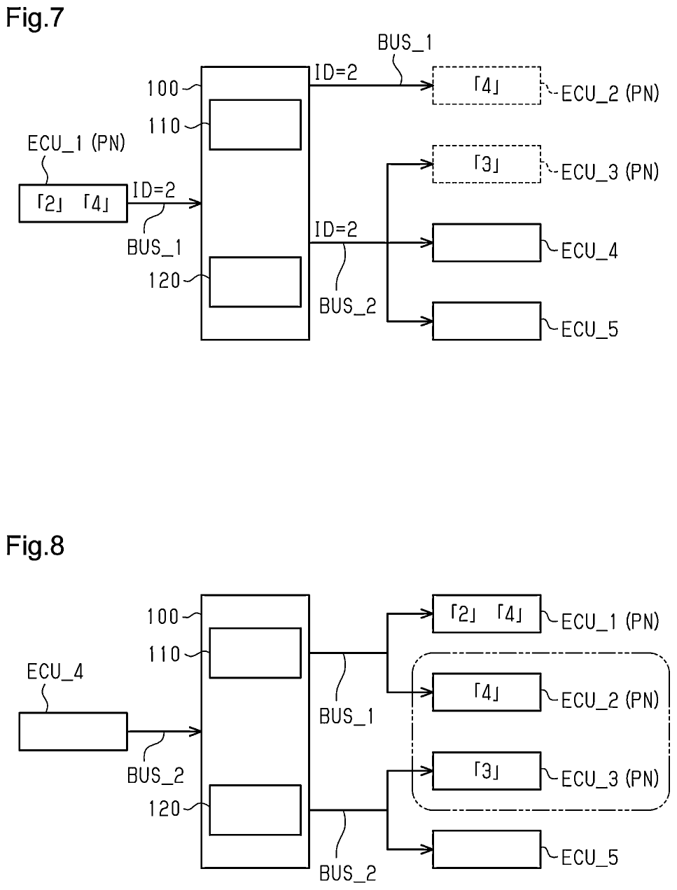

FIGS. 3 to 6 show a first comparative example of vehicle on-board network system that differs from the vehicle on-board network system shown in FIG. 1 in that all of the first to fifth electronic control units ECU_1 to ECU_5 are adapted to the partial network. FIGS. 7 to 10 show a second comparative example of vehicle on-board network system in which the fourth and fifth electronic control units ECU_4 and ECU_5 are not adapted to the partial network in the same manner as the vehicle on-board network system shown in FIG. 1.

### First Case in First Comparative Example

As shown in FIG. 2, the first function system is provided with “2” as group ID. The second function system is provided with “3” as group ID. The third function system is provided with “4” as group ID. The transceiver 230A of the electronic control unit ECU adapted to the partial network transmits an activation request message that includes a frame indicating the corresponding group ID as a frame for identifying the electronic control unit ECU that will be activated. The transceiver 230A of the electronic control unit ECU adapted to the partial network determines whether to ignore the activation request message with reference to the frame included in the activation request message. Each electronic control unit ECU adapted to the partial network is provided with the group ID of the activation request message that will be responded to instead of being ignored. Each transceiver 230A refers to the frame included in the received activation request message. When the group ID indicated by the frame matches the provided group ID, the transceiver 230A accepts the activation request message. Also, when the activation request message does not include a frame indicating the group ID, the transceiver 230A accepts the activation request message. When the activation request message is accepted, the electronic control unit ECU is activated from the sleep state and shifts to the active state. When the group ID indicated by the frame does not match the provided group ID, the transceiver 230A ignores the activation request message without accepting the activation request message. In this case, the electronic control unit ECU maintains the sleep state.

As shown in FIG. 2, the first application APL_1, the fourth application APL_4, and the sixth application APL_6 are executed to implement the function of the first function system. In the first comparative example, the first electronic control unit ECU_1, the fourth electronic control unit ECU_4, and the fifth electronic control unit ECU_5, which respectively include the applications APL described above, are provided with “2” as the group ID of the activation request message that will be followed instead of being ignored.

The third application APL_3 and the sixth application APL_6 are executed to implement the function of the second function system. In the first comparative example, the third electronic control unit ECU_3 and the fifth electronic control unit ECU_5, which respectively include the applications APL described above, are provided with “3” as the group ID of the activation request message that will be followed instead of being ignored.

The first application APL_1 and the second application APL_2 are executed to implement the function of the third function system. In the first comparative example, the first electronic control unit ECU_1 and the second electronic control unit ECU_2, which respectively include the applications APL described above, are provided with “4” as the group ID of the activation request message that will be followed instead of being ignored.

In other words, as shown in FIGS. 3 to 6, in the first comparative example, the first electronic control unit ECU_1 is provided with “2” and “4” as the group ID of the activation request message that will be followed instead of being ignored. The second electronic control unit ECU_2 is provided with “4” as the group ID of the activation request message that will be followed instead of being ignored. The third electronic control unit ECU_3 is provided with “3” as the group ID of the activation request message that will be followed instead of being ignored. The fourth electronic control unit ECU_4 is provided with “2” as the group ID of the activation request message that will be followed instead of being ignored. The fifth electronic control unit ECU_5 is provided with “2” and “3” as the group ID of the activation request message that will be followed instead of being ignored.

The activation request message transmitted from each electronic control unit ECU is relayed by the gateway device 100 and transmitted to the other electronic control units ECU. The processing device 110 of the gateway device 100 refers to the activation request message to recognize which one of the electronic control units ECU is in the active state.

The first case illustrates behavior of each electronic control unit ECU when the first electronic control unit ECU_1 transmits an activation request message to operate the first function system. As shown in FIG. 3, in the first case of the first comparative example, the activation request message is transmitted via the gateway device 100 to each electronic control unit ECU excluding the first electronic control unit ECU_1. The activation request message includes a frame indicating “2” as the group ID.

As shown in FIG. 3, the second electronic control unit ECU_2 is not provided with “2” as the group ID. Therefore, when receiving the activation request message, the transceiver 230A of the second electronic control unit ECU_2 does not accept and ignores the activation request message. The second electronic control unit ECU_2 is not activated and maintains the sleep state. In FIGS. 3 to 10, the electronic control units ECU maintaining the sleep state are indicated by broken lines. In FIGS. 3 to 10, the electronic control units ECU that are activated to shift to the active state are indicated by solid lines.

As shown in FIG. 3, the third electronic control unit ECU_3 is not provided with “2” as the group ID. Therefore, when receiving the activation request message, the transceiver 230A of the third electronic control unit ECU_3 does not accept and ignores the activation request message. The third electronic control unit ECU_3 is not activated and maintains the sleep state.

As shown in FIG. 3, the fourth electronic control unit ECU_4 is provided with “2” as the group ID. Therefore, when receiving the activation request message, the transceiver 230A of the fourth electronic control unit ECU_4 accepts the activation request message. The fourth electronic control unit ECU_4 is activated to shift to the active state.

As shown in FIG. 3, the fifth electronic control unit ECU_5 is provided with “2” as the group ID. Therefore, when receiving the activation request message, the transceiver 230A of the fifth electronic control unit ECU_5 accepts the activation request message. The fifth electronic control unit ECU_5 is activated to shift to the active state.

As described above, in the first case of the first comparative example, the first electronic control unit ECU_1, the fourth electronic control unit ECU_4, and the fifth electronic control unit ECU_5, which include the applications APL executed to implement the function of the first function system, are activated. The second electronic control unit ECU_2 and the third electronic control unit ECU_3, which do not include the applications APL executed to implement the function of the first function system, maintain the sleep state.

### Second Case in First Comparative Example

The second case illustrates behavior of each electronic control unit ECU when the fourth electronic control unit ECU_4 transmits an activation request message to operate the first function system.

As shown in FIG. 4, in the second case of the first comparative example, the activation request message is transmitted via the gateway device 100 to each electronic control unit ECU excluding the fourth electronic control unit ECU_4. The activation request message includes a frame indicating “2” as the group ID.

As shown in FIG. 4, the first electronic control unit ECU_1 is provided with “2” as the group ID. Therefore, when receiving the activation request message, the transceiver 230A of the first electronic control unit ECU_1 accepts the activation request message. The first electronic control unit ECU_1 is activated to shift to the active state.

As shown in FIG. 4, the second electronic control unit ECU_2 is not provided with “2” as the group ID. Therefore, when receiving the activation request message, the transceiver 230A of the second electronic control unit ECU_2 does not accept and ignores the activation request message. The second electronic control unit ECU_2 is not activated and maintains the sleep state.

As shown in FIG. 4, the third electronic control unit ECU_3 is not provided with “2” as the group ID. Therefore, when receiving the activation request message, the transceiver 230A of the third electronic control unit ECU_3 does not accept and ignores the activation request message. The third electronic control unit ECU_3 is not activated and maintains the sleep state.

As shown in FIG. 4, the fifth electronic control unit ECU_5 is provided with “2” as the group ID. Therefore, when receiving the activation request message, the transceiver 230A of the fifth electronic control unit ECU_5 accepts the activation request message. The fifth electronic control unit ECU_5 is activated to shift to the active state.

As described above, in the second case of the first comparative example shown in FIG. 4, the first electronic control unit ECU_1, the fourth electronic control unit ECU_4, and the fifth electronic control unit ECU_5, which include the applications APL executed to implement the function of the first function system, are activated. The second electronic control unit ECU_2 and the third electronic control unit ECU_3, which do not include the applications APL executed to implement the function of the first function system, maintain the sleep state.

### Third Case in First Comparative Example

The third case illustrates behavior of each electronic control unit ECU when the second electronic control unit ECU_2 transmits an activation request message to operate the third function system.

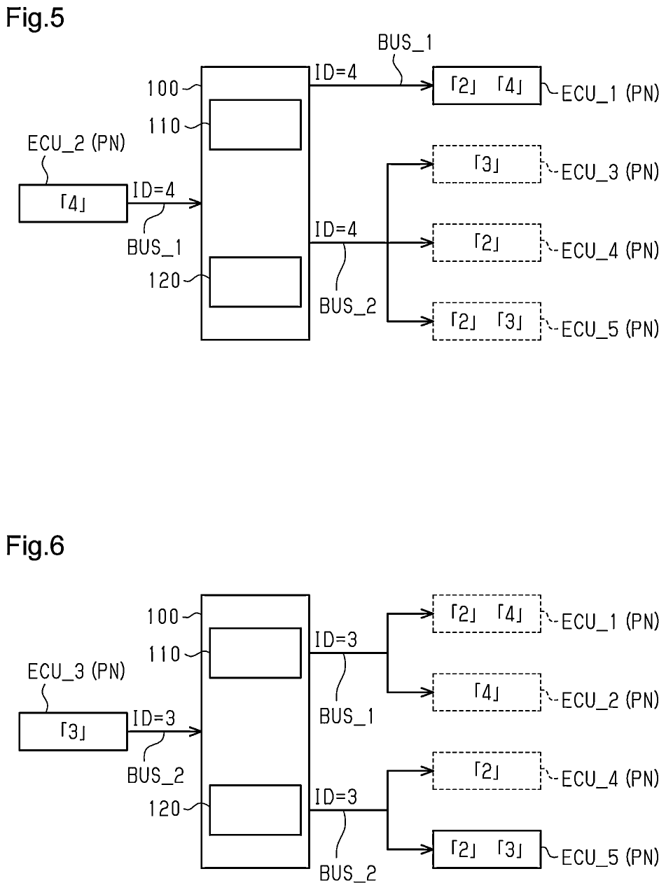

As shown in FIG. 5, in the third case of the first comparative example, the activation request message is transmitted via the gateway device 100 to each electronic control unit ECU excluding the second electronic control unit ECU_2. The activation request message includes a frame indicating “4” as the group ID.

As shown in FIG. 5, the first electronic control unit ECU_1 is provided with “4” as the group ID. Therefore, when receiving the activation request message, the transceiver 230A of the first electronic control unit ECU_1 accepts the activation request message. The first electronic control unit ECU_1 is activated to shift to the active state.

As shown in FIG. 5, the third electronic control unit ECU_3 is not provided with “4” as the group ID. Therefore, when receiving the activation request message, the transceiver 230A of the third electronic control unit ECU_3 does not accept and ignores the activation request message. The third electronic control unit ECU_3 is not activated and maintains the sleep state.

As shown in FIG. 5, the fourth electronic control unit ECU_4 is not provided with “4” as the group ID. Therefore, when receiving the activation request message, the transceiver 230A of the fourth electronic control unit ECU_4 does not accept and ignores the activation request message. The fourth electronic control unit ECU_4 is not activated and maintains the sleep state.

As shown in FIG. 5, the fifth electronic control unit ECU_5 is not provided with “4” as the group ID. Therefore, when receiving the activation request message, the transceiver 230A of the fifth electronic control unit ECU_5 does not accept and ignores the activation request message. The fifth electronic control unit ECU_5 is not activated and maintains the sleep state.

As described above, in the third case of the first comparative example shown in FIG. 5, the first electronic control unit ECU_1 and the second electronic control unit ECU_2, which include the applications APL executed to implement the function of the third function system, are activated. The third electronic control unit ECU_3, the fourth electronic control unit ECU_4, and the fifth electronic control unit ECU_5, which do not include the applications APL executed to implement the function of the third function system, maintain the sleep state.

### Fourth Case in First Comparative Example

The fourth case illustrates behavior of each electronic control unit ECU when the third electronic control unit ECU_3 transmits an activation request message to operate the second function system.

As shown in FIG. 6, in the fourth case of the first comparative example, the activation request message is transmitted via the gateway device 100 to each electronic control unit ECU excluding the third electronic control unit ECU_3. The activation request message includes a frame indicating “3” as the group ID.

As shown in FIG. 6, the first electronic control unit ECU_1 is not provided with “3” as the group ID. Therefore, when receiving the activation request message, the transceiver 230A of the first electronic control unit ECU_1 does not accept and ignores the activation request message. The first electronic control unit ECU_1 is not activated and maintains the sleep state.

As shown in FIG. 6, the second electronic control unit ECU_2 is not provided with “3” as the group ID. Therefore, when receiving the activation request message, the transceiver 230A of the second electronic control unit ECU_2 does not accept and ignores the activation request message. The second electronic control unit ECU_2 is not activated and maintains the sleep state.

As shown in FIG. 6, the fourth electronic control unit ECU_4 is not provided with “3” as the group ID. Therefore, when receiving the activation request message, the transceiver 230A of the fourth electronic control unit ECU_4 does not accept and ignores the activation request message. The fourth electronic control unit ECU_4 is not activated and maintains the sleep state.

As shown in FIG. 6, the fifth electronic control unit ECU_5 is provided with “3” as the group ID. Therefore, when receiving the activation request message, the transceiver 230A of the fifth electronic control unit ECU_5 accepts the activation request message. The fifth electronic control unit ECU_5 is activated to shift to the active state.

As described above, in the fourth case of the first comparative example shown in FIG. 6, the third electronic control unit ECU_3 and the fifth electronic control unit ECU_5, which include the applications APL executed to implement the function of the second function system, are activated. The first electronic control unit ECU_1, the second electronic control unit ECU_2, and the fourth electronic control unit ECU_4, which do not include the applications APL executed to implement the function of the second function system, maintain the sleep state.

As described above, in the first comparative example in which all of the electronic control units ECU are adapted to the partial network, in any case, only the electronic control units ECU that include the applications APL executed to implement the function of each function system are activated. That is, the vehicle on-board network system of the first comparative example, in which all of the electronic control units ECU are adapted to the partial network, minimizes activation of the electronic control units ECU, thereby reducing power consumption.

### First Case in Second Comparative Example

As described above, in a second comparative example of vehicle on-board network system, the fourth electronic control unit ECU_4 and the fifth electronic control unit ECU_5 are not adapted to the partial network. As described above, the first case illustrates behavior of each electronic control unit ECU when the first electronic control unit ECU_1 transmits an activation request message to operate the first function system.

As shown in FIG. 7, in the first case, the activation request message is transmitted via the gateway device 100 to each electronic control unit ECU excluding the first electronic control unit ECU_1. The activation request message includes a frame indicating “2” as the group ID.

As shown in FIG. 7, the second electronic control unit ECU_2 is not provided with “2” as the group ID. Therefore, when receiving the activation request message, the transceiver 230A of the second electronic control unit ECU_2 does not accept and ignores the activation request message. The second electronic control unit ECU_2 is not activated and maintains the sleep state.

As shown in FIG. 7, the third electronic control unit ECU_3 is not provided with “2” as the group ID. Therefore, when receiving the activation request message, the transceiver 230A of the third electronic control unit ECU_3 does not accept and ignores the activation request message. The third electronic control unit ECU_3 is not activated and maintains the sleep state.

In the second comparative example, the fourth electronic control unit ECU_4 is not adapted to the partial network. The transceiver 230B, which is mounted on an electronic control unit ECU that is not adapted to the partial network, does not have a configuration that checks the frame included in an activation request message and ignores an activation request message that is used to activate another electronic control unit ECU. Therefore, when receiving an activation request message, the transceiver 230B of the fourth electronic control unit ECU_4 accepts the activation request message. As a result, as shown in FIG. 7, the fourth electronic control unit ECU_4 is activated to shift to the active state.

The fifth electronic control unit ECU_5 is also not adapted to the partial network. Therefore, when receiving an activation request message, the transceiver 230B of the fifth electronic control unit ECU_5 accepts the activation request message. As a result, as shown in FIG. 7, the fifth electronic control unit ECU_5 is also activated to shift to the active state.

As described above, in the first case of the second comparative example shown in FIG. 7, the first electronic control unit ECU_1, the fourth electronic control unit ECU_4, and the fifth electronic control unit ECU_5, which include the applications APL executed to implement the function of the first function system, are activated. The second electronic control unit ECU_2 and the third electronic control unit ECU_3, which do not include the applications APL executed to implement the function of the first function system, maintain the sleep state.

### Second Case in Second Comparative Example

As described above, the second case illustrates behavior of each electronic control unit ECU when the fourth electronic control unit ECU_4 transmits an activation request message to operate the first function system.

As described above, in the second comparative example, the fourth electronic control unit ECU_4 is not adapted to the partial network. The transceiver 230B does not have a configuration that transmits an activation request message that includes information indicating group ID indicating which function system is activated. Hence, as shown in FIG. 8, the activation request message transmitted from the fourth electronic control unit ECU_4 does not include a frame indicating group ID. Therefore, in the second case of the second comparative example, the activation request message that does not include a frame indicating group ID is transmitted via the gateway device 100 to each electronic control unit ECU excluding the fourth electronic control unit ECU_4.

As described above, when the activation request message does not include a frame indicating group ID, the transceiver 230A accepts the activation request message. The transceiver 230B accepts the activation request message regardless of whether the activation request message includes a frame indicating group ID.

Thus, as shown in FIG. 8, in the second case of the second comparative example, all of the first electronic control unit ECU_1, the second electronic control unit ECU_2, the third electronic control unit ECU_3 and the fifth electronic control unit ECU_5, which receive the activation request message, are activated.

As shown in FIG. 4, in the second case of the first comparative example, the second electronic control unit ECU_2 and the third electronic control unit ECU_3, which do not include the applications APL used to operate the first function system, remain in the sleep state. In contrast, in the second case of the second comparative example, as surrounded by the double-dashed line in FIG. 8, the second electronic control unit ECU_2 and the third electronic control unit ECU_3 are activated to shift to the active state.

### Third Case in Second Comparative Example

As described above, the third case illustrates behavior of each electronic control unit ECU when the second electronic control unit ECU_2 transmits an activation request message to operate the third function system.

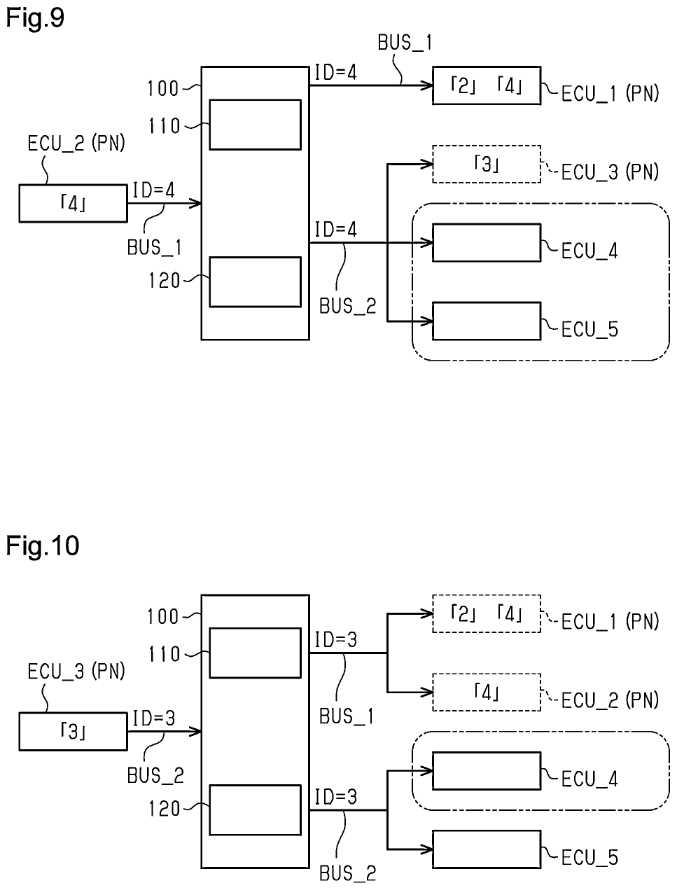

As shown in FIG. 9, in the third case, the activation request message is transmitted via the gateway device 100 to each electronic control unit ECU excluding the second electronic control unit ECU_2. The activation request message includes a frame indicating “4” as the group ID.

As shown in FIG. 9, the first electronic control unit ECU_1 is provided with “4” as the group ID. Therefore, when receiving the activation request message, the transceiver 230A of the first electronic control unit ECU_1 accepts the activation request message. The first electronic control unit ECU_1 is activated to shift to the active state.

As shown in FIG. 9, the third electronic control unit ECU_3 is not provided with “4” as the group ID. Therefore, when receiving the activation request message, the transceiver 230A of the third electronic control unit ECU_3 does not accept and ignores the activation request message. The third electronic control unit ECU_3 is not activated and maintains the sleep state.

As shown in FIG. 9, in the second comparative example, the fourth electronic control unit ECU_4 is not adapted to the partial network. Therefore, when receiving an activation request message, the transceiver 230B of the fourth electronic control unit ECU_4 accepts the activation request message. The fourth electronic control unit ECU_4 is activated to shift to the active state.

The fifth electronic control unit ECU_5 is also not adapted to the partial network. Therefore, when receiving an activation request message, the transceiver 230B of the fifth electronic control unit ECU_5 accepts the activation request message. The fifth electronic control unit ECU_5 is also activated to shift to the active state.

As shown in FIG. 5, in the third case of the first comparative example, the electronic control units ECU that do not include the applications APL used to implement the function of the third function system remain in the sleep state. More specifically, in the first comparative example, the third electronic control unit ECU_3, the fourth electronic control unit ECU_4, and the fifth electronic control unit ECU_5 remain in the sleep state. In contrast, in the third case of the second comparative example, as surrounded by the double-dashed line in FIG. 9, the fourth electronic control unit ECU_4 and the fifth electronic control unit ECU_5 are activated to shift to the active state.

### Fourth Case in Second Comparative Example

As described above, the fourth case illustrates behavior of each electronic control unit ECU when the third electronic control unit ECU_3 transmits an activation request message to operate the second function system.

As shown in FIG. 10, in the fourth case, the activation request message is transmitted via the gateway device 100 to each electronic control unit ECU excluding the third electronic control unit ECU_3. The activation request message includes a frame indicating “3” as the group ID.

As shown in FIG. 10, the first electronic control unit ECU_1 is not provided with “3” as the group ID. Therefore, when receiving the activation request message, the transceiver 230A of the first electronic control unit ECU_1 does not accept and ignores the activation request message. The first electronic control unit ECU_1 is not activated and maintains the sleep state.

As shown in FIG. 10, the second electronic control unit ECU_2 is not provided with “3” as the group ID. Therefore, when receiving the activation request message, the transceiver 230A of the second electronic control unit ECU_2 does not accept and ignores the activation request message. The second electronic control unit ECU_2 is not activated and maintains the sleep state.

As shown in FIG. 10, when receiving the activation request message, the fourth electronic control unit ECU_4 and the fifth electronic control unit ECU_5 are activated to shift to the active state since the transceivers 230B accept the activation request message.

As shown in FIG. 6, in the fourth case of the first comparative example, the electronic control units ECU that do not include the applications APL used to implement the function of the second function system remain in the sleep state. More specifically, in the first comparative example, the first electronic control unit ECU_1, the second electronic control unit ECU_2, and the fourth electronic control unit ECU_4 maintain the sleep state. In contrast, in the fourth case of the second comparative example, as surrounded by the double-dashed line in FIG. 10, the fourth electronic control unit ECU_4 is activated to shift to the active state.

As described above, when the vehicle on-board network system includes an electronic control unit ECU that is not adapted to the partial network, the electronic control unit ECU may be activated even when the activation is not necessary.

### Process of Vehicle On-Board Network System in Present Embodiment

In the vehicle on-board network system of the present embodiment, the gateway device 100 refers to the frame included in the activation request message to transmit the activation request message to only ones of the networks including the electronic control units ECU that need to be activated. To perform this configuration, as shown in FIG. 1, the storage device 120 of the gateway device 100 stores a first database 121 and a second database 122.

The first database 121 collectively includes combinations of the applications APL executed to implement each function. More specifically, the first database 121 shows the correspondence relationship of groups, that is, combinations of the applications APL simultaneously executed, and the applications APL belonging to each group. In an example, the first database 121 of the vehicle on-board network system shown in FIG. 1 stores information shown in the part surrounded by the broken line in FIG. 2.

The second database 122 shows the correspondence relationship of networks in the vehicle on-board network system and the applications APL executed by the electronic control units ECU belonging to each network. In an example, the second database 122 of the vehicle on-board network system shown in FIG. 1 stores information shown in the part surrounded by the solid line in FIG. 2.

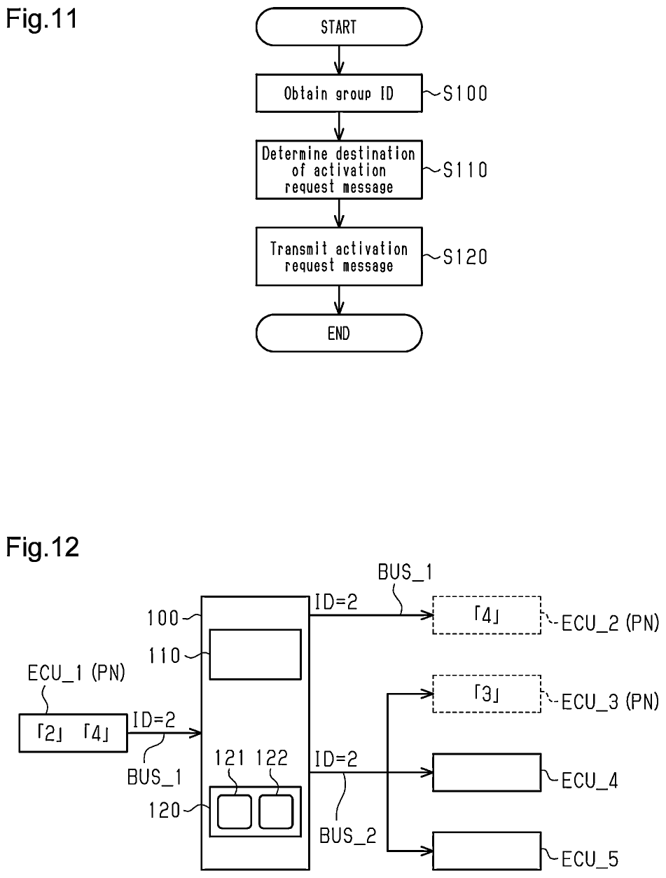

FIG. 11 shows the flow of a series of steps in a routine executed by the processing device 110 of the gateway device 100. The processing device 110 executes the routine whenever an activation request message is received from the electronic control units ECU.

As shown in FIG. 11, when the routine starts, in step S100, the processing device 110 obtains the group ID included in the activation request message. More specifically, the processing device 110 refers to the frame indicating the group ID included in the activation request message to obtain the group ID. When the activation request message does not include a frame indicating group ID, the processing device 110 fails to obtain group ID. In this case, the processing device 110 proceeds to step S110 without obtaining group ID.

In step S110, the processing device 110 determines a destination of the activation request message. More specifically, the processing device 110 refers to the obtained group ID, the first database 121, and the second database 122 to identify the network including the electronic control units ECU that need to be activated. The processing device 110 determines the destination of the activation request message so that the activation request message is transmitted to only ones of the networks including the electronic control units ECU that need to be activated.

As shown in FIG. 2, when information of the first database 121 and information of the second database 122 are combined, the processing device 110 identifies the network including the ECUs that need to be activated based on the group ID.

For example, when the obtained group ID is “4,” as shown in FIG. 2, the first application APL_1 and the second application APL_2 are necessary. The first electronic control unit ECU_1, which executes the first application APL_1, and the second electronic control unit ECU_2, which executes the second application APL_2, both belong to the network formed by the first communication bus BUS_1. Thus, the processing device 110 recognizes that the network including the electronic control units ECU that need to be activated is the network formed by the first communication bus BUS_1. The processing device 110 also recognizes that the network that does not include the electronic control units ECU that need to be activated is the network formed by the second communication bus BUS_2.

When failing to obtain the group ID, the processing device 110 determines the destination of the activation request message so that the activation request message is transmitted to all of the networks.

In step S120, the processing device 110 transmits the activation request message to the networks of the destination.

As described above, in the vehicle on-board network system of the present embodiment, the processing device 110 refers to the frame included in the activation request message to determine the destination of the activation request message. The processing device 110 determines the destination so that the activation request message is transmitted to a network that includes the electronic control units ECU that need to be activated and is not transmitted to a network that does not include the electronic control units ECU that need to be activated. The processing device 110 refers to the frame included in the activation request message to determine the destination of the activation request message. The gateway device 100 transmits the activation request message to only the network including the electronic control units ECU that need to be activated.

When failing to obtain the group ID, the processing device 110 determines the destination of the activation request message so that the activation request message is transmitted to all of the networks. The gateway device 100 transmits the activation request message to all of the networks.

### Operation of Present Embodiment

The operation of the present embodiment will be described with reference to FIGS. 12 to 15 using the first to fourth cases.

### The First Case in Vehicle On-Board Network System of Present Embodiment

In the vehicle on-board network system of the present embodiment, the fourth electronic control unit ECU_4 and the fifth electronic control unit ECU_5 are not adapted to the partial network, which is the same as the second comparative example. As described above, the first case illustrates behavior of each electronic control unit ECU when the first electronic control unit ECU_1 transmits an activation request message to operate the first function system.

As shown in FIG. 12, in the first case, the first electronic control unit ECU_1 transmits an activation request message to the gateway device 100. The activation request message includes a frame indicating “2” as the group ID.

The gateway device 100 receives the activation request message to obtain the group ID (S100). The gateway device 100 determines the destination of the activation request message with reference to the frame included in the activation request message, the first database 121, and the second database 122 (S110).

As shown in FIG. 2, the applications APL corresponding to the group ID of “2” are the first application APL_1, the fourth application APL_4, and the sixth application APL_6. The first electronic control unit ECU_1 executing the first application APL_1 belongs to the network formed by the first communication bus BUS_1. The fourth electronic control unit ECU_4, which executes the fourth application APL_4, and the fifth electronic control unit ECU_5, which executes the sixth application APL_6, both belong to the network formed by the second communication bus BUS_2. That is, in this case, the network formed by the first communication bus BUS_1 and the network formed by the second communication bus BUS_2 each correspond to the network including the electronic control units ECU that need to be activated. The processing device 110 sets the network formed by the first communication bus BUS_1 and the network formed by the second communication bus BUS_2 as the destination of the activation request message.

As indicated by arrows in FIG. 12, the gateway device 100 transmits the activation request message to the network formed by the first communication bus BUS_1 and the network formed by the second communication bus BUS_2 (S120).

As shown in FIG. 12, the second electronic control unit ECU_2 is not provided with “2” as the group ID. Therefore, when receiving the activation request message, the transceiver 230A of the second electronic control unit ECU_2 does not accept and ignores the activation request message. The second electronic control unit ECU_2 is not activated and maintains the sleep state.

As shown in FIG. 12, the third electronic control unit ECU_3 is not provided with “2” as the group ID. Therefore, when receiving the activation request message, the transceiver 230A of the third electronic control unit ECU_3 does not accept and ignores the activation request message. The third electronic control unit ECU_3 is not activated and maintains the sleep state.

In the vehicle on-board network system of the present embodiment, the fourth electronic control unit ECU_4 is not adapted to the partial network. As described above, the transceiver 230B, which is mounted on an electronic control unit ECU that is not adapted to the partial network, does not have a configuration that checks the frame included in an activation request message and ignores an activation request message that is used to activate another electronic control unit ECU. Therefore, when receiving an activation request message, the transceiver 230B of the fourth electronic control unit ECU_4 accepts the activation request message. As a result, as shown in FIG. 12, the fourth electronic control unit ECU_4 is activated to shift to the active state.

The fifth electronic control unit ECU_5 is also not adapted to the partial network. Therefore, when receiving an activation request message, the transceiver 230B of the fifth electronic control unit ECU_5 accepts the activation request message. As a result, as shown in FIG. 12, the fifth electronic control unit ECU_5 is also activated to shift to the active state.

As described above, in the first case of the present embodiment shown in FIG. 12, the first electronic control unit ECU_1, the fourth electronic control unit ECU_4, and the fifth electronic control unit ECU_5, which include the applications APL executed to implement the function of the first function system, are activated. The second electronic control unit ECU_2 and the third electronic control unit ECU_3, which do not include the applications APL executed to implement the function of the first function system, maintain the sleep state.

### Second Case in Vehicle On-Board Network System of Present Embodiment

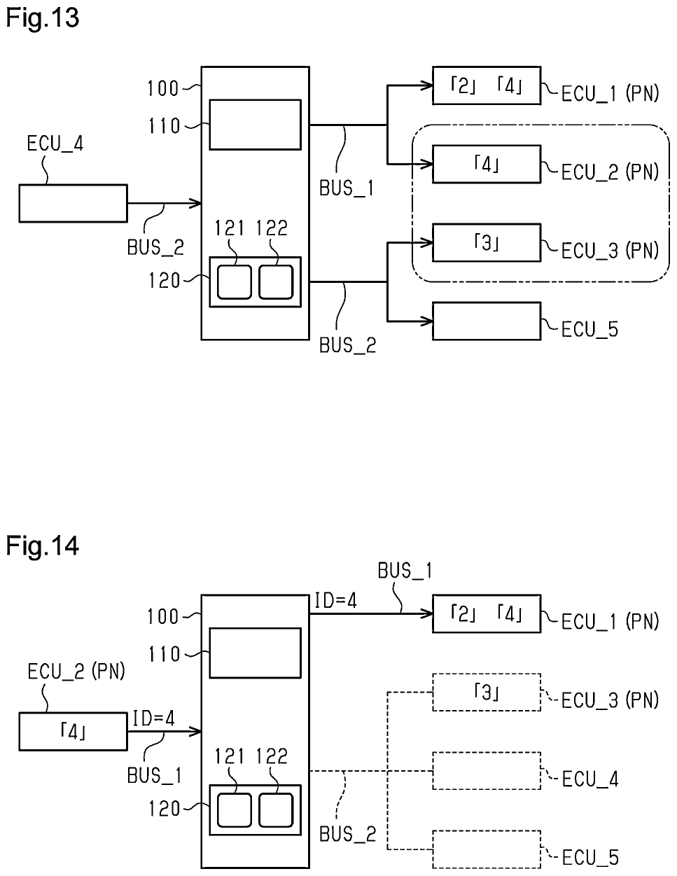

As described above, the second case illustrates behavior of each electronic control unit ECU when the fourth electronic control unit ECU_4 transmits an activation request message to operate the first function system. In the second case, as shown in FIG. 13, the fourth electronic control unit ECU_4 transmits the activation request message to the gateway device 100.

In the vehicle on-board network system of the present embodiment, the fourth electronic control unit ECU_4 is not adapted to the partial network. The transceiver 230B does not have a configuration that transmits an activation request message that includes information indicating group ID indicating which function system is activated. Hence, as shown in FIG. 13, the activation request message transmitted from the fourth electronic control unit ECU_4 does not include a frame indicating group ID.

The gateway device 100 receives the activation request message. The activation request message does not include a frame indicating group ID. Thus, the gateway device 100 fails to obtain group ID (S100). The gateway device 100 sets the network formed by the first communication bus BUS_1 and the network formed by the second communication bus BUS_2 as the destination of the activation request message (S110).

As indicated by arrows in FIG. 13, the gateway device 100 transmits the activation request message to the network formed by the first communication bus BUS_1 and the network formed by the second communication bus BUS_2 (S120).

As described above, when the activation request message does not include a frame indicating group ID, the transceiver 230A accepts the activation request message. The transceiver 230B accepts the activation request message regardless of whether the activation request message includes a frame indicating group ID.

Thus, as shown in FIG. 13, in the second case of the present embodiment, all of the electronic control units ECU are activated in the same manner as the second case of the second comparative example shown in FIG. 8.

As shown in FIG. 4, in the second case of the first comparative example, the second electronic control unit ECU_2 and the third electronic control unit ECU_3, which do not include the applications APL used to operate the first function system, maintain the sleep state. In contrast, in the second case of the second comparative example, as surrounded by the double-dashed line in FIG. 8, the second electronic control unit ECU_2 and the third electronic control unit ECU_3 are also activated to shift to the active state. Also, in the second case of the present embodiment, as surrounded by the double-dashed line in FIG. 13, the second electronic control unit ECU_2 and the third electronic control unit ECU_3 are activated to shift to the active state.

### Third Case in Vehicle On-Board Network System of Present Embodiment

As described above, the third case illustrates behavior of each electronic control unit ECU when the second electronic control unit ECU_2 transmits an activation request message to operate the third function system.

As shown in FIG. 14, in the third case, the second electronic control unit ECU_2 transmits an activation request message to the gateway device 100. The activation request message includes a frame indicating “4” as the group ID.

The gateway device 100 receives the activation request message to obtain the group ID (S100). The gateway device 100 determines the destination of the activation request message with reference to the frame included in the activation request message, the first database 121, and the second database 122 (S110).

As shown in FIG. 2, the applications APL corresponding to the group ID of “4” are the first application APL_1 and the second application APL_2. The first electronic control unit ECU_1 executing the first application APL_1 belongs to the network formed by the first communication bus BUS_1. The second electronic control unit ECU_2 executing the second application APL_2 also belongs to the network formed by the first communication bus BUS_1. Thus, in this case, the network formed by the first communication bus BUS_1 is the network including the electronic control units ECU that need to be activated. The processing device 110 sets the network formed by the first communication bus BUS_1 as the destination of the activation request message.

As indicated by arrows in FIG. 14, the gateway device 100 transmits the activation request message to only the network formed by the first communication bus BUS_1 (S120).

As shown in FIG. 14, the first electronic control unit ECU_1 is provided with “4” as the group ID. Therefore, when receiving the activation request message, the transceiver 230A of the first electronic control unit ECU_1 accepts the activation request message. The first electronic control unit ECU_1 is activated to shift to the active state.

As indicated by broken lines in FIG. 14, the activation request message is not transmitted to the network formed by the second communication bus BUS_2. Thus, the third electronic control unit ECU_3, the fourth electronic control unit ECU_4, and the fifth electronic control unit ECU_5 are not activated and maintain the sleep state.

In the third case of the second comparative example, as surrounded by the double-dashed line in FIG. 9, the fourth electronic control unit ECU_4 and the fifth electronic control unit ECU_5 are activated to shift to the active state. In the third case of the present embodiment, in the vehicle on-board network system, the third electronic control unit ECU_3, the fourth electronic control unit ECU_4, and the fifth electronic control unit ECU_5, which do not need to be activated, are not activated and remain the sleep state.

### Fourth Case in Vehicle On-Board Network System of Present Embodiment

As described above, the fourth case illustrates behavior of each electronic control unit ECU when the third electronic control unit ECU_3 transmits an activation request message to operate the second function system.

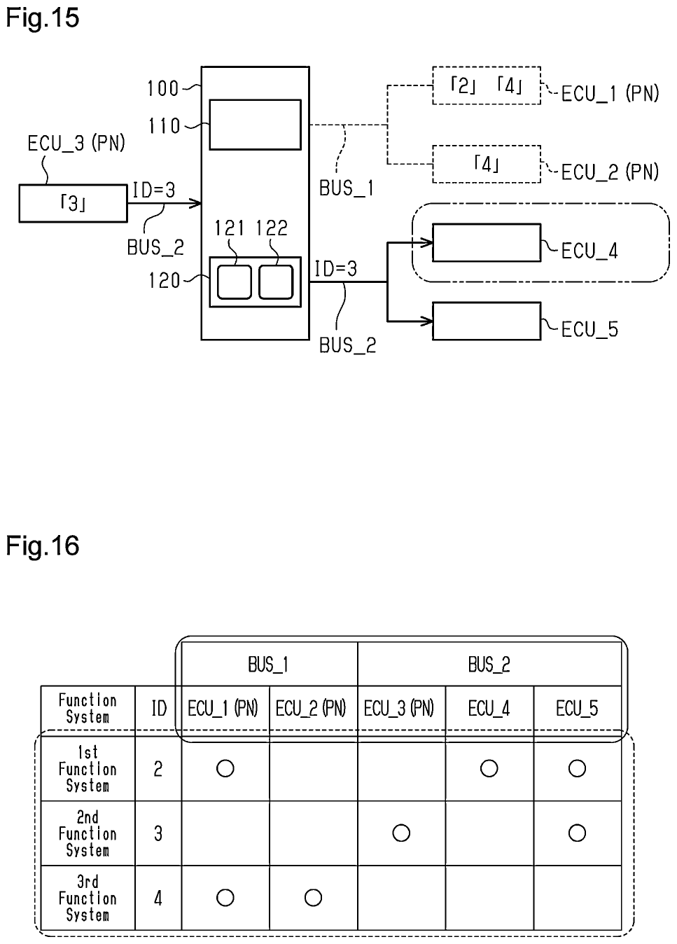

As shown in FIG. 15, in the fourth case, the third electronic control unit ECU_3 transmits an activation request message to the gateway device 100. The activation request message includes a frame indicating “3” as the group ID.

The gateway device 100 receives the activation request message to obtain the group ID (S100). The gateway device 100 determines the destination of the activation request message with reference to the frame included in the activation request message, the first database 121, and the second database 122 (S110).

As shown in FIG. 2, the applications APL corresponding to the group ID of “3” are the third application APL_3 and the sixth application APL_6. The third electronic control unit ECU_3 executing the third application APL_3 belongs to the network formed by the second communication bus BUS_2. The fifth electronic control unit ECU_5 executing the sixth application APL_6 also belongs to the network formed by the second communication bus BUS_2. Thus, in this case, the network formed by the second communication bus BUS_2 is the network including the electronic control units ECU that need to be activated. The processing device 110 sets the network formed by the second communication bus BUS_2 as the destination of the activation request message.

As indicated by arrows in FIG. 15, the gateway device 100 transmits the activation request message to only the network formed by the second communication bus BUS_2 (S120).

As shown in FIG. 15, when receiving the activation request message, the fourth electronic control unit ECU_4 and the fifth electronic control unit ECU_5 are activated to shift to the active state since the transceivers 230B accept the activation request message.

As indicated by the broken line in FIG. 15, the activation request message is not transmitted to the network formed by the first communication bus BUS_1. Thus, the first electronic control unit ECU_1 and the second electronic control unit ECU_2 are not activated and maintain the sleep state.

As shown in FIG. 6, in the fourth case of the first comparative example, the electronic control units ECU that do not include the applications APL executed to implement the function of the second function system maintain the sleep state. More specifically, in the first comparative example, the first electronic control unit ECU_1, the second electronic control unit ECU_2, and the fourth electronic control unit ECU_4 maintain the sleep state. In contrast, in the fourth case of the second comparative example, as surrounded by the double-dashed line in FIG. 10, the fourth electronic control unit ECU_4 is activated to shift to the active state. Also, in the fourth case of the present embodiment, as surrounded by the double-dashed line in FIG. 15, the fourth electronic control unit ECU_4 is activated to shift to the active state.

### Advantages of Present Embodiment

(1) The vehicle on-board network system of the present embodiment is configured to perform communication in compliance with the CAN protocol. When complying with the CAN protocol, when an electronic control unit ECU that is adapted to the partial network receives an activation request message that does not include a frame requesting activation of the electronic control unit ECU, the electronic control unit ECU ignores the activation request message. That is, the electronic control unit ECU maintains the sleep state. In contrast, an electronic control unit ECU that is not adapted to the partial network does not have a configuration that ignores the activation request message. Thus, when the electronic control unit ECU that is not adapted to the partial network receives an activation request message, the electronic control unit ECU is activated from the sleep state to shift to the active state regardless of whether the activation request message includes a frame requesting activation of the electronic control unit ECU.

In the vehicle on-board network system of the present embodiment, the processing device 110 of the gateway device 100 determine the destination of the activation request message with reference to the frame included in the activation request message. The gateway device 100 transmits the activation request message to a network that includes the electronic control units ECU that need to be activated and does not transmit the activation request message to a network that does not include the electronic control units ECU that need to be activated. Thus, in the vehicle on-board network system of the present embodiment, the electronic control unit ECU that is not adapted to the partial network and arranged in the network that does not include the electronic control units ECU that need to be activated will not be activated. For example, as in the third case described with reference to FIG. 14, the electronic control units ECU that are not adapted to the partial network will not be activated.

(2) In the vehicle on-board network system of the embodiment, even when an electronic control unit ECU is added to any network, the second database 122 may be updated to correspond to the change of the configuration of the network.

(3) In the vehicle on-board network system of the embodiment, when a function system is added, additional applications APL are executed by the electronic control units ECU. The first database 121 may be updated to correspond to the addition of the applications APL.

(4) Each electronic control unit ECU includes the timer 220 that increments a count value when the electronic control unit ECU is in the active state, and resets the count value when the electronic control unit ECU accepts an activation request message. The electronic control unit ECU shifts to the sleep state when the count value reaches a predetermined value.

In the vehicle on-board network system including the electronic control unit ECU including the timer 220 as described above, when the electronic control unit ECU accepts the activation request message, the count value is reset. The electronic control unit ECU that is not adapted to the partial network does not have a configuration that ignores the activation request message. Thus, when the electronic control unit ECU that is not adapted to the partial network is activated to shift to the active state, the count value is reset whenever the activation request message is received, and the electronic control unit ECU is less likely to shift to the sleep state.

In the vehicle on-board network system of the present embodiment, the activation request message will not be transmitted to the network that does not include the electronic control units ECU that need to be activated. This avoids a situation in which the count value of the timer 220 of the electronic control unit ECU that is not adapted to the partial network is reset by an activation request message for activating other electronic control units ECU. The vehicle on-board network system of the present embodiment ensures the electronic control unit ECU that is not adapted to the partial network appropriately shifts to the sleep state. Thus, power consumption is reduced.

(5) The gateway device 100 is used in a vehicle on-board network system in which some of the electronic control units ECU are connected by one of the communication buses BUS to form a network, and the electronic control units ECU communicate with each other in compliance with the CAN protocol via the gateway device 100. The gateway device 100 is connected to multiple networks and relays communication between the electronic control units ECU. The gateway device 100 includes the processing device 110. When the gateway device 100 receives an activation request message including a frame identifying the electronic control units ECU that need to be activated, the processing device 110 refers to the frame included in the activation request message to determine the destination of the activation request message. The processing device 110 determines the destination of the activation request message so that the activation request message is not transmitted to a network that does not include the electronic control units ECU that need to be activated and is transmitted to a network that includes the electronic control units ECU that need to be activated.

When the gateway device 100 is used in such a vehicle on-board network system, the electronic control units ECU that are not adapted to the partial network will not be activated in the same manner as the vehicle on-board network system of the embodiment even if differing in structure from the vehicle on-board network system of the embodiment. That is, the gateway device 100 inhibits activation of the electronic control units ECU that are not adapted to the partial network, thereby reducing power consumption of the vehicle on-board network system.

(6) The communication method of the vehicle on-board network system of the present embodiment includes first to third steps described below.

The first step corresponds to step S100 in the flowchart shown in FIG. 11. In the first step, the gateway device 100 receives an activation request message including a frame identifying the electronic control units ECU that need to be activated from an electronic control unit ECU.

The second step corresponds to step S110 in the flowchart shown in FIG. 11. In the second step, the gateway device 100 refers to the frame included in the received activation request message to determine the destination of the activation request message. In the second step, the gateway device 100 determines the destination of the activation request message so that the activation request message is not transmitted to a network that does not include the electronic control units ECU that need to be activated and is transmitted to a network that includes the electronic control units ECU that need to be activated.

In the third step, the gateway device 100 transmits the activation request message to only the network that is determined to be the destination in the second step.

With the communication method described above, the electronic control units ECU that are not adapted to the partial network will not be activated.

### Modified Examples

The embodiments described above may be modified as follows. The embodiments and the following modified examples can be combined within a range where the combined modified examples remain technically consistent with each other.

The first database 121 and the second database 122 are not limited to those of the embodiment. For example, the storage device 120 of the gateway device 100 may store the first database 121 and the second database 122 that are described below.

In a modified example, the first database 121 shows the correspondence relationship of groups, that is, combinations of electronic control units ECU that are simultaneously operated, and electronic control units ECU belonging to each group. In a modified example used in the configuration of the vehicle on-board network system of the embodiment, the first database 121 stores information shown in the part surrounded by the broken line in FIG. 16.

In a modified example, the second database 122 shows the correspondence relationship of networks and electronic control units ECU belonging to each network. In a modified example used in the configuration of the vehicle on-board network system of the embodiment, the second database 122 stores information shown in the part surrounded by the solid line in FIG. 16.

In the vehicle on-board network system of this modified example, the processing device 110 determines the destination of the activation request message with reference to the frame included in the activation request message, the first database 121, and the second database 122.

In the vehicle on-board network system of this modified example, each electronic control unit ECU is activated in the same manner as the cases described with reference to FIGS. 12 to 15. Thus, the vehicle on-board network system of this modified example obtains the same advantages as those of the embodiment.

In the embodiment, each electronic control unit ECU includes the timer 220. When the count value controlled by the timer 220 reaches the predetermined value, the electronic control unit ECU shifts to the sleep state. The condition for the electronic control unit ECU to shift to the sleep state is not limited to that described above. Hence, each electronic control unit ECU does not have to include the timer 220.

The processing device 110 may include 1) processing circuitry including one or more processors that execute various processes according to a computer program (software); 2) processing circuitry including one or more dedicated hardware circuits such as application specific integrated circuits (ASIC) that execute at least part of various processes, or 3) processing circuitry including a combination thereof. The processor includes a CPU and memory such as RAM and ROM. The memory stores program codes or instructions configured to cause the CPU to execute processes. The memory, or a computer readable medium, includes any type of medium that is accessible by a general-purpose computer or a dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle on-board network system, comprising:
networks each including electronic control units and a communication bus connecting the electronic control units to each other; and
a gateway device connected to the networks and configured to allow the electronic control units to communicate with each other in compliance with a CAN protocol, wherein
the gateway device includes processing circuitry,
when the gateway device receives an activation request message including a frame identifying one or more of the electronic control units that need to be activated, the processing circuitry is configured to determine a destination of the activation request message, and
the processing circuitry is configured to determine the destination of the activation request message, with reference to the frame included in the activation request message, so that the gateway device does not transmit the activation request message to one or more of the networks that do not include the one or more of the electronic control units that need to be activated, whereas the gateway device transmits the activation request message to one or more of the networks that include the one or more of the electronic control units that need to be activated.

2. The vehicle on-board network system according to claim 1, wherein
each of the electronic control units includes at least one of applications,
two or more of the applications are combined and simultaneously executed to implement each of functions,
the gateway device includes a storage device,
the storage device stores a first database and a second database,
the first database shows a correspondence relationship of groups, each of the groups being a combination of two or more of the applications simultaneously executed, and one or more of the applications belonging to each of the groups,
the second database shows a correspondence relationship of the networks and the applications executed by the electronic control units belonging to each of the networks,
the frame included in the activation request message indicates a group of two or more of the applications that need to be executed, and
to determine the destination of the activation request message, the processing circuitry is configured to identify one or more of the networks that do not include the one or more of the electronic control units that need to be activated with reference to the frame included in the activation request message, the first database, and the second database.

3. The vehicle on-board network system according to claim 1, wherein
the gateway device includes a storage device,
the storage device stores a first database and a second database,
the first database shows a correspondence relationship of groups, each of the groups being a combination of two or more of the electronic control units simultaneously executed, and one or more of the electronic control units belonging to each of the groups,
the second database shows a correspondence relationship of the networks and the electronic control units belonging to each of the networks,
the frame included in the activation request message indicates a group of the electronic control units that need to be activated, and
to determine the destination of the activation request message, the processing circuitry is configured to identify one or more of the networks that do not include the one or more of the electronic control units that need to be activated with reference to the frame included in the activation request message, the first database, and the second database.

4. The vehicle on-board network system according to claim 1, wherein
each electronic control unit includes a timer configured to increment a count value when the electronic control unit is in an active state, and to reset the count value when the electronic control unit accepts the activation request message, and
the electronic control unit is configured to shift to a sleep state when the count value reaches a predetermined value.

5. A gateway device used in a vehicle on-board network system, wherein the vehicle on-board network system includes networks connected to the gateway device, each network includes electronic control units and a communication bus connecting the electronic control units to each other, and the gateway device is configured to relay communication between the electronic control units so that the electronic control units communicate with each other in compliance with a CAN protocol, the gateway device comprising:
processing circuitry, wherein
when the gateway device receives an activation request message including a frame identifying one or more of the electronic control units that need to be activated, the processing circuitry is configured to determine a destination of the activation request message, and
the processing circuitry is configured to determine the destination of the activation request message, with reference to the frame included in the activation request message, so that the gateway device does not transmit the activation request message to one or more of the networks that do not include the one or more of the electronic control units that need to be activated, whereas the gateway device transmits the activation request message to one or more of the networks that include the one or more of the electronic control units that need to be activated.

6. A communication method in a vehicle on-board network system, wherein the vehicle on-board network system includes networks each including electronic control units and a communication bus connecting the electronic control units to each other and a gateway device connected to the networks and configured to relay communication between the electronic control units so that the electronic control units communicate with each other in compliance with a CAN protocol, the communication method, comprising:
with the gateway device, receiving, from at least one of the electronic control units, an activation request message including a frame identifying one or more of the electronic control units that need to be activated;
with the gateway device, determining a destination of the activation request message, with reference to the frame included in the activation request message, so that the activation request message is not transmitted to one or more of the networks that do not include the one or more of the electronic control units that need to be activated, whereas the activation request message is transmitted to one or more of the networks that include the one or more of the electronic control units that need to be activated; and
with the gateway device, transmitting the activation request message to only the one or more of the networks determined to be the destination.
